(19) United States
(12) Patent Application Publication
(10) Pub. No.: US 2013/0345363 A1
(43) Pub. Date: Dec. 26, 2013

(54) BIODEGRADABLE IMPACT-MODIFIED POLYMER COMPOSITIONS

(71) Applicant: Arkema Inc., King of Prussia, PA (US)

(72) Inventors: Zuzanna DONNELLY, Ardmore, PA (US); Mehdi M. Emad, Collegeville, PA (US)

(73) Assignee: Arkema Inc., King of Prussia, PA (US)

(21) Appl. No.: 14/013,225

(22) Filed: Aug. 29, 2013

Related U.S. Application Data
(63) Continuation-in-part of application No. 12/996,119, filed on Dec. 3, 2010, now Pat. No. 8,524,832.
(60) Provisional application No. 61/061,323, filed on Jun. 13, 2008.

(51) Int. Cl. C08L 67/04; C08L 33/06

(52) U.S. Cl. CPC C08L 67/04; C08L 33/06
USPC 525/190

(57) ABSTRACT

The invention relates to an impact-modified bio-degradable polymer composition having large particle size impact modifiers dispersed in a continuous biodegradable polymer phase. The impact modifiers have a core-shell morphology and may have average sizes of greater than 250 nm. The impact-modified composition has good impact properties and low haze, The biodegradable polymer is preferably a polylactide or polyhydroxy butyrate. The composition comprises 30-99.9 weight percent of degradable polymer and 0.1 to 15 weight percent of one or more impact modifiers.

### CROSS REFERENCE TO RELATED APPLICATIONS

This application is a continuation-in-part of and claims priority to U.S. application Ser. No. 12/996,119, filed Dec. 3, 2010 (corresponding to U.S. Pat. No. 8,524,832 to be issued on Sep. 3, 2013) which is a national stage application under 35 U.S.C. §371 of PCT/US2009/045568, filed May 29, 2009, which claims priority to U.S. Provisional Application No. 61/061,323, filed Jun. 13, 2008, each of which is incorporated herein by reference in its entirety for all purposes,

### FIELD OF THE INVENTION

The invention relates to impact-modified bio-degradable polymer compositions having large particle size impact modifiers dispersed in a continuous biodegradable polymer phase. The impact modifiers have of the core-shell morphology and have average sizes of greater than 250 nm. The impact-modified composition has good impact properties and low haze.

### BACKGROUND OF THE INVENTION

The growing global concern over persistent plastic waste has generated much interest in biodegradable polymers for everyday use, Biodegradable polymers based on polylactic acid (PLA) are one of the most attractive candidates as they can be readily produced from renewal agricultural sources such as corn. Recent developments in the manufacturing of the polymer economically from agricultural sources have accelerated the polymers emergence into the biodegradable plastic commodity market.

Linear acrylic copolymers have been disclosed for use as process aids in a blend with a biopolymer, such as polylactide, (US Application 2007-0179218), The disclosed linear acrylic copolymers do not provide satisfactory impact properties. Additives such as impact modifiers could be used in the polylactide composition.

One problem with many biodegradable polymers, such as polylactide, is the very brittle nature of the pure polymer. This property results in very low impact properties of finished articles, much lower than what is desirable for adequate product performance. Impact modifiers, such as methylmethacrylate-butadiene-styrene (MBS) and acrylic core-shell or block copolymers, are known to improve the impact properties of PVC and polycarbonate blends.

Block copolymers and core-shell polymers have been described for use in biodegradable polymers in PCT/US07184502, This application is silent of particle size.

WO 2008/051443 describes clear impact modified polylactide resins. The resins are modified with bimodal core-shell impact modifiers, and the number average particle size of all particles and agglomerates in less than 210 nanometers.

Surprisingly it has been found that core-shell impact modifiers having a number average particle size of greater than 250 can be used in a biodegradable plastic, and still achieve excellent impact modification and low haze.

### SUMMARY OF THE INVENTION

The invention relates to a biodegradable polymer composition comprising:
a) 30 to 99.9 weight percent of one or more biodegradable polymers;
b) 0-69.9 weight percent of one or more biopolymer; and
c) 0.1 to 15 weight percent of one or more core-shell impact modifiers,

wherein said impact modifiers have a number average particle size of greater than 250 nm.

The biodegradable polymer composition may be clear or translucent, and preferably has a haze of less than 15.

### DETAILED DESCRIPTION OF THE INVENTION

The biodegradable polymer of the invention can be a single biodegradable polymer, or a mixture of biodegradable polymers. Some examples of biodegradable polymers useful in the invention include, but are not limited to, polylactide and polyhydroxy butyrate. The biodegradable composition comprises 30 to 99.9 weight percent of the one or more biodegradable polymers.

The preferred polylactide and polyhydroxy butyrate can be a normal or low molecular weight.

In addition to the biodegradable polymer(s), other bio-polymers, such as, but not limited to starch, cellulose, and polysaccharides may also be present. Additional biopolymers, such as but not limited to polycaprolactam, polyamide 11 and aliphatic or aromatic polyesters may also be present. The other bio-polymers may be present in the composition at from 0-69.9 weight percent.

One or more impact modifiers may be used at from 0.1 to 15 weight percent of the composition.

The impact modifier is a core/shell impact modifier. The core-shell (multi-layer) impact modifiers could have a soft (rubber or elastomer) core and a hard shell, a hard core covered with a soft elastomer-layer, and a hard shell, of other core-shell morphology known in the art. The rubber layers are composed of low glass transition (Tg) polymers, including, but not limited to, butyl acrylate (BA), ethylhexyl acrylate (EHA), butadiene (BD), butylacrylate/styrene, and many other combinations. In a preferred, the core is an all-acrylic homopolymer or co-polymer. It has been found that acrylic cores lead to a biodegradable polymer composition having lower haze than with the diene core polymers.

The preferred glass transition temperature (Tg) of the elastomeric layer should be below 25° C. The elastomeric or rubber layer is normally crosslinked by a multifunctional monomer for improved energy absorption. Crosslinking monomers suitable for use as the crosslinker in the core/shell impact modifier are well known to those skilled in the art, and are generally monomers copolymerizable with the monounsaturated monomer present, and having ethylenically multifunctional groups that have approximately equal reactivity. Examples include, but are not limited to, divinylbenzene, glycol of di- and trimethacrylates and acrylates, triol triacrylates, methacrylates, and allyl methacrylates, etc. A grafting monomer is also used to enhance the interlayer grafting of impact modifiers and the matrix/modifier particle grafting. The grafting monomers can be any polyfunctional crosslinking monomers.

For soft core multi-layered impact modifies, the core ranges from 30 to 95 percent by weight of the impact modifier, and outer shells range from 15-70 weight percent. The crosslinker in the elastomeric layer ranges from 0 to 5.0%. The synthesis of core-shell impact modifiers is well known in the art, and there are many references, for example U.S. Pat. No. 3,793,402, U.S. Pat. No. 3,808,180, U.S. Pat. No. 3,971,835, and U.S. Pat. No. 3,671,610, incorporated herein by reference. The refractive index of the modifier particles, and/or matrix polymer, can be matched against each other by using copolymerizable monomers with different refractive indices. Preferred monomers include, but are not limited to, styrene, alpha methylstyrene, and vinylidene fluoride monomers having unsaturated ethylenic group.

Other non-core/shell impact modifiers are also possible for use in this invention, where super transparency and clarity may not be required. For example butadiene rubber can be incorporated into an acrylic matrix to achieve high ballistic resistance property.

In a preferred embodiment, the core-shell polymer is 80-90% of an acrylic core, and a shell comprised of 75-100 weight % methyl methacrylate, 0-20 weight percent butyl acrylate and 0-25 weight percent ethyl acrylate. The acrylic core is preferably selected from a butyl acrylate homopolymer, and ethylhexyl acrylate homopolymer, or a copolymer of butyl acrylate and ethylhexyl acrylate at any monomer ratio.

In one embodiment, the acrylic copolymer impact modifier is an acrylate based copolymer with a core-shell polymer having a rubbery core, such as 1,3-dienes (also copolymers with vinyl aromatics) or alkyl acrylates with alkyl group containing 4 or more carbons and the shell is grafted onto the core and is comprised of monomers such as vinyl aromatics (e.g., styrene), alkyl methacrylates (alkyl group having 1-4 carbons), alkyl acrylates (alkyl group having 1-4 carbons), and acrylonitrile.

A preferred acrylic type core/shell polymer is one having a 70-90% core of 0-100 weight % butylacrylate, 0-100% 2-ethylhexyl acrylate and 0-35% butadiene, and a shell comprised of 75-100 weight % methyl methacrylate, 0-20 weight percent butyl acrylate and 0-25 weight percent ethyl acrylate.

The core-shell impact modifiers of the invention are particles having a number average particle size of over 250 nm, preferably from 250 to 400 nm, and most preferably from 280 to 330 nm. The core-shell impact modifier can be a blend of two or more sizes or chemical compositions, however the number average particle size of all the impact modifier particles is greater than 250 nm. Particle size may be measured using a NiComp 380 dynamic light scattering particle size analyzer under normal operating conditions. Gaussian intensity-weighted mean diameter may be reported.

Preferably the impact modifiers of the biodegradable polymer composition of the invention are pellets or powders comprising, consisting essentially of, or consisting of impact modifier particles having the number average particle size described herein.

Impact modifier pellets of the invention include small, shaped, masses that may be of any shape including but not limited to round, spherical, cylindrical, and the like.

Pellets of impact modifier may be formed using melt processing techniques such as extrusion or other techniques. Where pellets are formed using melt processing, the pellet may be extruded. For example, an impact modifier in pellet form may be achieved by melt processing techniques such as single or twin screw extrusion, or by co-kneading extrusion with reciprocating screws such as a Buss Co-Kneader and Banbury type mixers. The final pellets may be formed using strand methods or other means of pelletizing.

Processing temperatures may be controlled by controlling the temperature of the respective barrel sections of the extruder (front, middle, and back) and may range from about 150-460° F., preferably from about 200° F.-450 even more preferably from about 300 to 400° F.

Preferably the extruder may be operated at an RPM of from about 140 to 300 RPM, preferably from about 150 to 250 RPM, and a feed rate/output of about 10 Kg/hr.

Preferably, the pelletization process minimizes shear heating (low shear) and temperature of the impact modifiers while forming finished pellets having the desired size, shape, composition, and molecular weight. For example, the size and/or shape of the impact modifier pellets may substantially correspond to the size and/or shape of the biodegradable polymer pellets with which it may be combined as described herein.

Alternatively, the pellets may be cold pressed.

Impact modifiers in powder form may be problematic in some applications such as injection molding Where powders, for example, may clump and/or form undesirable blocks. Whereas feeding powder into equipment may be costly and difficult, impact modifier pellets avoids these problems.

Another advantage of pelletization of impact modifiers is that it permits easy, convenient processing without resulting separation of components. For example, pelletization of impact modifiers permits bag mixing or tumbling mixing with other pelletized products with low or even no separation or settling of individual components. Pelletization also may substantially reduce and even eliminate dusting and associated potential problems that may sometimes be associated with the use of powders.

Use of impact modifier pellets also provides for the manufacture of a biodegradable polymer composition of the invention at lower manufacturing costs, better efficiencies due to the need for less processing equipment, greater consistency of final product, and increased ease of handling.

The impact modifiers of the invention may also be powder comprising, consisting essentially of, or consisting of impact modifier particles having the number average particle size described herein. Impact modifier powders may be formed using spray drying or coagulation.

The bio degradradable polymer composition of the invention may contain 30-99.9 weight percent of the biodegradable polymer, 0-69.9 weight percent of other biopolymers and from 0.1-15 weight percent of the acrylic copolymer(s). The ingredients may be admixed prior to processing, or may be combined during one or more processing steps, such as a melt-blending operation. This can be done, for instance by single-screw extrusion, twin-screw extrusion, Buss kneader, two-roll mill, impeller mixing. Any admixing operation resulting in a homogeneous distribution of acrylic-methacrylic copolymer in the biodegradable polymer is acceptable, Formation of the blend is not limited to a single-step formation. Masterbatch formation of 15-99% acrylic-methacrylic copolymer in 1-85% carrier polymer followed by subsequent addition to the biodegradable polymer to derive a final blend is also anticipated. The carrier polymer may be, but is not limited to, polylactide, acrylic-methacrylic copolymers, and methacrylic homopolymers.

In addition to the biodegradable polymer, biopolymer and impact modifier adding up to 100 percent, the composition of the invention may additionally contain a variety of additives, including but not limited to, heat stabilizers, internal and external lubricants, other impact modifiers, process aids, melt strength additives, fillers, and pigments.

The composition of the invention was found to have greatly improved the impact properties over the polylactide alone. The core-shell polymer impact modifiers provide excellent impact modification, while still providing a low haze.

The impact-modified biodegradable polymer composition can range from almost clear or translucent, to opaque, depending on the composition and level of impact modification. In one embodiment, the impact-modified biodegradable polymer has a haze level of below 15 percent, preferably below 12 percent when measured by ASTM 1003-00.

The composition of the invention can be processed using any known method, including but not limited to injection molding, extrusion, calendaring, blow molding, foaming and thermoforming. Useful articles that can be made using the biodegradable compositions, include but are not limited to packaging materials, films and bottles. One in the art can imagine a variety of other useful articles and processes for forming those articles, based on the disclosure and examples herein.

### EXAMPLES

### Example 1

Blends of 95 and 93.5% polylactide containing 5 and 7.5% by weight of acrylic-methacrylic copolymer impact modifier was formed by melt extrusion using a twin-screw extruder. The processing temperature and melt temperature during extrusion were maintained above the melting temperature of polylactide (>152° C.) to ensure a homogeneous melt. The extrudate was cast into a sheet (17-22 mil) using a 3 roll stack and puller. Haze measurements were performed on the sheet using a Colorimeter and dart drop impact measurements were performed with a Gardner Impact tester with a 2 lb hemispherical impactor head. The data observed is shown in Table 1 below:

TABLE 1

| | | mean failure | |
|---|---|---|---|
| | particle size | energy [ft lb] | haze |
| 5% modifier | | | |
| A | 280 | 7.0 | 5.0 |
| B | 330 | 6.1 | 7.3 |
| C | 450 | 7.6 | 24.3 |
| 7.5% modifier | | | |
| A | 280 | 10.5 | 9.9 |
| B | 330 | 10.3 | 9.2 |
| C | 450 | 15.4 | 48.6 |

### Example 2

### Impact Modifier Pelletization Using a Twin Screw Co-Rotating Intermeshing Extruder

Acrylic-methacrylic copolymer impact modifier was formed into pellets using the following equipment: a co-rotating twin screw with inner meshing screws and equipped with two vent ports, having an L/D (length/diameter) of 40/1, and equipped with heating band temperature controllers capable of air cooling. The twin screw was a commercially available 27 mm twin screw with a screw design that operated at 260 RPM and a feed rate/output of 10Kg/hr.

During the pelletization process, the temperature profile of the barrel was controlled such that ⅓ of the barrel was set at about 455° C. (at the front area), the middle ⅓ of the barrel. heated to about 437° C. and the back portion (including feed area) was heated to about 410° C. The temperature profile of the barrel may be adjusted accordingly depending on the brand and model of the extruder and feed rate.

A water bath and a strand pelletizer were placed downstream of the twin screw. The cutting speed of the pelletizer was adjusted based on the desired pellet length.

What is claimed is:

1. A biodegradable polymer composition comprising:
a) 30 to 99.9 weight percent of one or more biodegradable polymers;
b) 0 to 69.9 weight percent of one or more biopolymers; and
c) 0.1 to 15 weight percent of one or more core-shell impact modifiers,
wherein said impact modifier is a pellet comprising particles having a number average particle size of greater than 250 nm, and wherein said composition has a haze of less than 15 percent as measured by ASTM 1003-00.

2. A biodegradable polymer composition comprising:
a) 30 to 99.9 weight percent of one or more biodegradable polymers;
b) 0 to 69.9 weight percent of one or more biopolymers; and
c) 0.1 to 15 weight percent of one or more core-shell impact modifiers,
wherein said impact modifier is a powder comprising particles having a number average particle size of greater than 250 nm, and wherein said composition has a haze of less than 15 percent as measured by ASTM 1003-00.

3. A biodegradable polymer composition of claim 1, wherein said biodegradable polymer is polylactide, polyhydroxy butyrate, or a mixture thereof.

4. The biodegradable polymer composition of claim 1, wherein said impact modifier has a number average particle size of from greater than 250 nm to 400 nm.

5. The biodegradable polymer composition of claim 1, wherein said impact modifier has a number average particle size of from 280 to 330 rim.

6. The biodegradable polymer composition of claim 3, wherein said polylactide has a weight average molecular weight of from 10,000-3,000,000 g/mol.

7. The biodegradable polymer composition of claim 1 wherein the core-shell impact modifier are a blend of two or more copolymers.

8. The biodegradable polymer composition of claim 1, Wherein said biopolymer comprises one or more polymers selected from the group consisting of starch, cellulose, polysaccharides, aliphatic or aromatic polyesters, and polycaprolactone.

9. The biodegradable polymer composition of claim 1, wherein said core-shell impact modifier is an all-acrylic core/shell polymer.

10. The biodegradable polymer composition of claim 1, wherein the core of said core-shell impact modifier comprises one or more monomer units selected from the group consisting of butyl acrylate, and ethylhexylacrylate.

11. The biodegradable polymer composition of claim 1, wherein the core of said core-shell impact modifier is polybutyl acrylate.

12. The biodegradable polymer composition of claim 1, wherein the biopolymer comprises one or more of starch, cellulose, and polycaprolactone,

13. The biodegradable polymer composition of claim 1, wherein the shell of the core/shell impact modifier comprises 75-100 weight % methyl methacrylate, 0-20 weight percent butyl acrylate and 0-25 weight percent ethyl acrylate, and wherein the core of said core-shell impact modifier comprises one or more monomer units selected from the group consisting of butyl acrylate, and ethylhexylacrylate.
